(19) United States
(12) Patent Application Publication
(10) Pub. No.: US 2011/0276621 A1
(43) Pub. Date: Nov. 10, 2011

(54) OPERATING SYSTEM AND APPLICATION VIRTUALIZATION FOR APPLICATION EXECUTION

(75) Inventors: Yigal Edery, Pardesia (IL); Lidiane Souza, Maiden, MA (US)

(73) Assignee: Microsoft Corporation, Redmond, WA (US)

(21) Appl. No.: 12/773,912

(22) Filed: May 5, 2010

(51) Int. Cl. G06F 9/455; G06F 15/16

(52) U.S. Cl. 709/203; 718/1

(57) ABSTRACT

A system for executing a virtual application may use a virtualized operating system to execute an application. The application may be delivered to a host device through streaming, either to a streaming client in the virtual operating system or as a package that may include the virtualized operating system. The virtualized operating system may have a user interface connection to a host operating system to make the virtual application appear as a native application in the host operating system.

### BACKGROUND

Backwards compatibility is one area of concern for information technology managers when considering upgrading an operating system. In many businesses or other environments, some applications may execute in an older operating system and the applications may not be supported in a later version. While users may benefit from having a newer operating system with more features, the information technology managers may not want to upgrade because of legacy issues with older applications.

### SUMMARY

A system for executing a virtual application may use a virtualized operating system to execute an application. The application may be delivered to a host device through streaming, either to a streaming client in the virtual operating system or as a package that may include the virtualized operating system. The virtualized operating system may have a user interface connection to a host operating system to make the virtual application appear as a native application in the host operating system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a network environment in which a virtualized application may be executed.

FIG. 2 is a timeline illustration of an embodiment showing a method for installing and executing streaming virtual applications.

FIG. 3 is a flowchart illustration of an embodiment showing a method for executing virtual applications.

### DETAILED DESCRIPTION

An application may be virtualized by executing the application inside a virtualized environment that may separate the application from other applications executing on a device. The virtualized environment may be a virtual operating system that has certain connections to a host operating system. The application may be executed in several manners, including streaming into the virtualized operating system and streaming the operating system and application as an executable package. The application may be packaged and executed using a virtual application client that may separate the application from other applications and the operating system in which the application executes.

The virtualized operating system may have user interface connections to the host operating system so that a user may be able to interact with the virtualized application using similar techniques as a natively executed application. A user of the host operating system may be able to interact with the virtualized application as if the application were operating natively on the host operating system. The virtual application may appear in a graphical user interface, and interactions such as drag and drop, file and printer sharing with the host operating system, object linking between native applications and the virtualized application, and other functions may be available.

The virtual application may create a graphical user interface that may be displayed alongside a graphical user interface of one or more other native applications. In many cases, the host operating system may provide a window with various controls so that the virtual application's graphical user interface may be manipulated like any other window within the host operating system. Example of the controls may be to expand, resize, minimize, move, or otherwise manipulate the graphical user interface.

In many embodiments, applications may be streamed to a client device or packaged for distribution on a client device. A streaming embodiment may allow remote management and distribution of applications to client devices without having to install and manage the applications on each client device.

A packaged distribution may allow a client device to install and execute an application complete with a virtualized operating system without having to be concerned with interference or compatibility issues with other applications or a host operating system.

The application virtualization may allow older clients with older operating systems to execute new applications within a new operating system, as well as execute legacy applications that may only operate on older or other incompatible operating systems. The centralized hosting and streaming of the virtual applications may allow rapid deployment and provisioning while avoiding incompatibility problems.

The term “application virtualization”, for the purposes of this specification and claims may refer to any mechanism by which an application may be isolated. In a first virtualization mechanism, the application may be isolated from other applications by using a virtualization client that may separate the application from other applications. In a second virtualization mechanism, the application may be isolated by executing the application within a virtualized operating system. In some embodiments, the client used for the first virtualization mechanism may be employed in the virtualized operating system in the second virtualization mechanism.

The term “virtualization client” or “virtual application client” may be a mechanism that isolates an application from other applications. A virtual application client may have a private namespace in which resources used by the application are located, and the private namespace may not be accessible by other applications. The private namespace may be populated by the application when the application is packaged for virtualization. In some embodiments, the virtualization client may or may not support streaming, where the application may be stored on another device and transmitted on request to the device on which the application is being executed.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

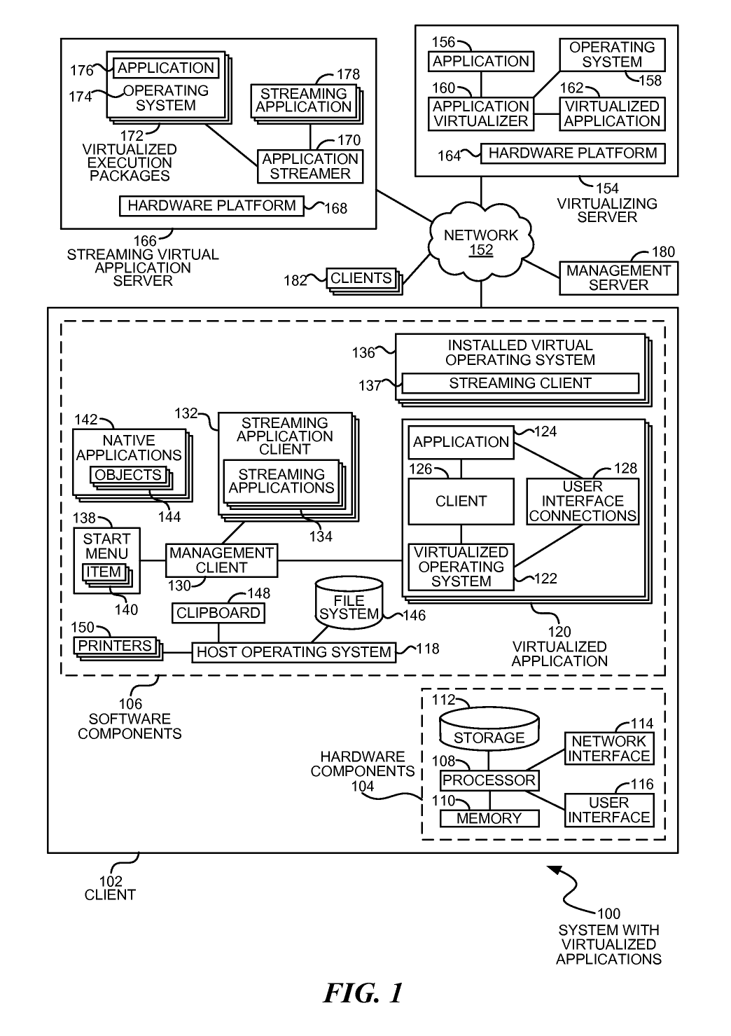

FIG. 1 is a diagram of an embodiment 100, showing a client and server components for a streaming virtualized application. Embodiment 100 is a simplified example of a network environment that may include a client device that may receive and execute virtualized applications using a virtualized operating system.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is an example of a network environment in which streaming and virtualized applications may be executed. An application may operate within a virtualized operating system, enabling the application to execute in a different operating system than a host operating system, but still have user interface connections so that the user may experience the virtualized application in the same manner as a natively executing application.

The virtualized application may have several use scenarios. In a first use scenario, a virtualized application may be executed on a legacy operating system. For example, an older application that may be infrequently used by an enterprise may not justify the expense of re-writing the application or porting the application to a newer operating system. In such a case, the application may be deployed with a virtualized version of the older operating system onto computer systems with a newer operating system. The user may enjoy the features of the newer operating system while still having access to the legacy application.

In another use scenario, applications may be developed for specific types of operating systems that are incompatible with other operating systems. For example, a first application may be developed using an open source operating system and a second application developed using a proprietary operating system. The virtualized operating system of embodiment 100 may allow either application to be executed on either operating system.

The virtualized applications may be delivered by streaming. In a streaming operation, a client device may request a portion of the application from a server, and the server may download enough of the application so that the client device may start executing the application. The client device may not have the entire application on local storage, but may have enough of the application so that execution may begin. When the application attempts to use portions that have not been downloaded, the client may request those portions from the server.

The virtualized applications may be delivered by self-contained packages that may include a virtualized operating system and the application. The packages may be installed and operate as a native application, except that the execution of the application may launch a virtualized operating system in which the application may execute.

In some cases, the application system may operate in a virtualized environment created by a virtualization client. The virtualization client may serve as an interface between an operating system and the application so that the application may be executed separate from other applications and, in some respects, separate from the operating system. The virtualization client may separate the application's configurations and data from that of other applications and the operating system.

For example, applications that operate in a native operating system may have various registry settings, initiation files, shared libraries, and other configurations that may be shared with other applications. The virtualization client may separate the virtualized application's configuration information from configuration information in the native operating system. The result may be that two incompatible applications may execute side by side without interference or incompatibility problems.

A virtualized operating system may execute within a host operating system. The virtualized operating system may operate with a modified hypervisor that may replicate a hardware platform to the virtualized operating system but may provide connections to the user interface of the host operating system. In such a system, the virtualized operating system may function separately and independently of the host operating system, but may include user interface connections so that the user may experience the virtualized operating system as another application on the host operating system.

The user interface connections between the virtualized operating system may include connections for copy and paste through a clipboard object, object linking and embedding, file sharing from the host operating system to the virtualized operating system, printer sharing, and other elements.

Embodiment 100 illustrates various components that may be used to deliver an application in two forms: with an operating system and without. When the virtual application is distributed with the virtualized operating system, the application may be pre-installed into the virtual operating system. When the virtual application is distributed without the virtualized operating system, the application may be streamed into a client in the virtualized operating system. In such an embodiment, the virtual operating system may be launched, then the application streamed to the client within the virtual operating system. In one such embodiment, a client in the host operating system may pass instructions to the virtual application client in the virtual operating system to connect to a streaming application server.

In embodiments where the virtual application is distributed with the operating system, a package comprising both the virtual operating system and the pre-installed application may be streamed to the client or distributed and installed to the client. In some such embodiments, the application may be configured to execute natively within the virtual operating system. In other embodiments, the application may be configured to operate virtually within the virtual operating system.

In an embodiment where the virtual application may be distributed without the virtual operating system, the virtual operating system may be pre-installed or otherwise available to a host operating system. In such an embodiment, the virtual operating system may include a virtual application client that may communicate with a streaming application server to retrieve the application by streaming.

A virtual application may be distributed in several different manners. In a conventional client-server streaming configuration, a client device may have a client application that may create an environment in which an application may be streamed. In such an embodiment, the client device may execute the application, but the executable code may be obtained from a streaming server that may transmit portions of the application on request to the client.

In another distribution manner, the virtual application may be packaged and transmitted to the client as a self-contained package. In the package, the virtualized operating system may contain the entire virtual application, and the package may be executed using a client application that may launch the virtual operating system and cause the application to execute.

The client 102 may represent a conventional computing device with a set of hardware components 104 and software components 106. The architecture of the client 102 may be that of a conventional desktop or sever computer, as well as of a game console, network appliance, or other device. In some cases, the client 102 may be a laptop computer, netbook computer, mobile telephone, personal digital assistant, or other portable device.

The hardware components 104 may include a processor 108, random access memory 110, and nonvolatile storage 112. The hardware components 104 may also include a network interface 114 and a user interface 116.

The software components 106 may include a host operating system 118 in which various applications and other components may operate.

A virtualized application 120 may operate with a virtualized operating system 122 in either a streaming or non-streaming mode. When streamed, a client 126 may retrieve portion of the application 124 on request from a virtual application server 166. In a non-streamed mode, the application 124 may be stored locally and executed within the virtualized operating system.

When used in a streaming embodiment, the client 126 may request portions of the application 124 from a streaming application server 166 and start the execution of the application. As requested, additional portions of the application may be retrieved. The client 126 may perform handshaking and other communication with the streaming virtual application server 166. Such a communication may involve establishing communications with the server 166, authenticating a request for the application 124, and performing any background management of the application 124.

When used in a non-streaming mode, the client 126 may provide isolation of the application from any other application that may be executing within the virtualized operating system 122. In some cases, two or more clients 126 may be executing different applications within the same virtualized operating system 122.

In many embodiments, access to virtual applications may be controlled or limited by the device or user. When access to a virtual application may be defined by device, each device may be permitted access to a set of virtual applications. When access may be defined by the user, each user may be permitted access to certain virtual applications. In some embodiments, access may be defined for a combination of devices and users. In order to access a virtual application, credentials for the device and/or the user may be presented to the virtual application server 166 prior to being allowed access to the application.

The client 126 may perform some of the management of a streamed application. In a streamed application, portions of the application may be downloaded to the client 102 to launch the application, then other portions may be downloaded on demand. The client 126 may monitor the requested portions of the virtual application and may communicate with the virtual application server 166 to request and download portions of the virtual application.

The virtualized operating system may operate within the host operating system 118 by using a hypervisor that includes user interface connections 128. The user interface connections 128 that may enable interaction between the application 124 and other applications or operating system features, and may enable the application 124 to appear as if the application 124 was a native application.

For example, access to a clipboard 148 may allow cut and paste operations between two different applications, one of which may be the application 124. In another example, the native file system 146 that may be managed and accessed through the host operating system 118 may be made available to the application 124. In still another example, printers 150 may also be made available to the virtualized application.

A management client 130 may interact with a management server 180 to install and configure virtual applications for the client 102. The management server 180 may provide links or other information that may be used by a client 126 to communicate with the virtual application server 166 and launch the streamed application 124. In some embodiments, the management client 130 may install an item 140 in a start menu 138 that may be a script, link, executable, or other item that may be selected by a user to launch the streamed application 124.

The management client 130 may interact with the management server 180 to install and configure streamed applications 134 which may use a streaming client 132. The streaming client 132 may isolate the streaming application 134 from other native applications 142 and the host operating system 118.

The management client 130 may also interact with the management server 180 to install and configure native applications 142 for the client 102. Native applications 142 may be those applications that operate within the host operating system 118.

In many embodiments, a streaming application client 132 may operate in the host operating system 118 to launch streaming applications 134. The streaming applications 134 may operate like the application 124; however, the applications 134 may operate within the host operating system 118. The applications 134 may be virtualized or separated from other applications, such as the native applications 142.

The native applications 142 may be conventional applications that execute natively in the host operating system 118. Such applications may not be virtualized and may interact with various settings and components available to other native applications, such as registry settings, initialization files, shared dynamic linked libraries, or other components.

The native applications 142 may include various objects 144 that may be shared to other applications, including the virtual applications 124 and 134. The objects 144 may be, for example, files or other objects that may be embedded in the content of another application. In a typical example, a word processor application may include an embedded object from a spreadsheet application. The embedded object may be linked to a spreadsheet application from within the word processor document. In many embodiments, the applications 124 and 134 may operate to accept links to other virtual applications or the objects 144 from native applications 142. Similarly, many embodiments may allow objects created by the applications 124 and 134 to be embedded and linked in the native applications 142.

In some embodiments, a client 102 may have pre-installed virtual operating systems 136. The pre-installed virtual operating systems 136 may include an application client 137. In one use scenario, an item 140 may be selected by a user to launch a particular virtual application. A management client 130 may launch the virtualized operating system 122 as an instance of the pre-installed virtual operating system 136 and pass a command, script, or other information to the streaming client 126, which may in turn launch the virtualized application 124.

The client 102 may connect to a network 152 that may have a virtualizing server 154. The virtualizing server 154 may create packages of virtualized applications, and in some cases the packages may include virtualized versions of an operating system.

The virtualizing server 154 may include a hardware platform 164, which may be similar to the hardware components 104 of client 102. The virtualizing server 154 may take an application 156 and operating system 158 and, using an application virtualizer 160, create a virtualized application 162. The virtualized application 162 may be a package that may be consumed by a virtual application client, such as the streaming client 132 to execute the application 156 in a virtual manner.

In some embodiments, the application virtualizer 160 may create a virtualized application 162 through static analysis of the application. Static analysis may involve analyzing the executable code of the application 156 to create a package. In other embodiments, the application virtualizer 160 may execute the application 156 and analyze the application while the application 156 is being executed to create the package.

The packages that include the virtualized application 162 may be distributed to the client 102 through two different mechanisms: streaming and direct installation. In a streaming mechanism, a client device may connect to a streaming application server to download and execute the application. In a direct installation, the package may be distributed to the client devices, installed on the client devices, and executed from the client devices.

The virtualized application 162 may include the virtualized application without the operating system 158. In such embodiments, a client 102 may execute the virtualized application in the host operating system 118 using a streaming application client 132. When the virtualized application 162 is configured for another operating system, the client 102 may launch a virtualized operating system 122 from which the streaming client 126 may call the virtual application.

The virtualized application 162 may include a virtualized copy of the operating system 158. In such embodiments, a client 102 may use a streaming application client 132 or management client 130 to launch the package as a virtualized application 120.

The virtualizing server 154 may provide virtualized execution packages 172 that may include both an operating system 174 and an application 176. In some embodiments, the application 176 may be a native application within the operating system 174. In other embodiments, the application 176 may be virtualized within the operating system 174.

The virtual application server 166 may also include a streaming application 178 that may not include an operating system. Such a streaming application 178 may define a specific operating system or groups of operating systems on which the streaming application 178 may execute.

The virtual application server 166 may have an application streamer 170 that may stream the various virtual application packages to a client device. The application streamer 170 may download an initial portion of an application package so that the client device may begin executing the virtual application.

In some embodiments, the application streamer 170 may download an initial portion of an application using a high speed transmission so that the response time at a client device is minimized. After the initial portion of the virtual application has been consumed by the client device, the application streamer 170 may download remaining portions of the application in a slower manner. If a portion has not been downloaded but a client requests the portion, the application streamer 170 may download the requested portion at high speed and then return to lower speed downloads.

A management server 180 may manage the various virtual applications with respect to the client 102 and other clients 182. The management server 180 may transmit configuration information to management clients operating on the client devices, such as the management client 130 operating on the client 102. The management server 180 may transmit an installation package that may include a manifest or other listing of available virtual applications, and the management client 130 may configure the client 102 to be able to execute the virtual applications.

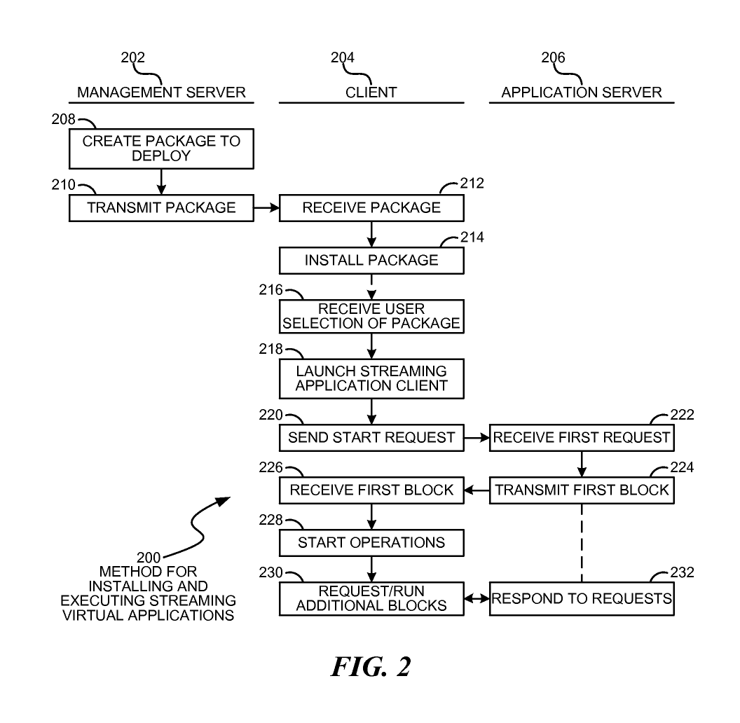

FIG. 2 is a timeline illustration of an embodiment 200 showing a method for installing and executing streaming virtual applications. Embodiment 200 illustrates the operations of a management server 202 in the left hand column, a client 204 in the center column, and an application server 206 in the right hand column. The management server 202 may correspond with the operations of the virtualizing server 154 and management server 180 of embodiment 100. The client 204 may correspond with the client 102 of embodiment 100, and the application server 206 may correspond with the virtual application server 166 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates some of the interactions that may occur between various devices in a network with streaming virtual applications. The management server 202 may create a package to deploy in block 208. The package may be transmitted in block 210 and received by the client 204 in block 212.

The package of block 208 may be an installation package that may be installed in block 214. The installation package may include links, scripts, or other mechanisms that may be used by a client to communicate with an application server 206 to retrieve the executable code for an application. The installation package may not include the application to which the installation package refers.

In some embodiments, the installation package may include permissions or restrictions that may define which users, groups of users, devices, or device types that may be permitted to access a virtual application. In some embodiments, the installation package may include an identifier for an operating system or group of operating systems that may execute the virtual environment. When the user selects the application, a management client may determine if the host operating system may be capable of executing the virtual application. If not, the management client may start a virtual operating system in which the virtual application may be executed. An example embodiment of such a process may be found in embodiment 300 presented later in this specification.

In block 216, a user selection may be received and a streaming application client may be launched in block 218. The streaming application client may send a start request in block 220 to the application server 206, which may receive the first request in block 222.

In response to an initial request for a virtual application, the application server 206 may generate the first portion of the application that the client 204 may use to start executing the application. The portion may be transmitted in block 224, received by the client 204 in block 226, and the virtual application may begin executing in block 228.

As the streamed application begins to execute in block 228, any actions of the application that point to portions of the application that are not downloaded may be requested in block 230, responded to by the application server 206 in block 232. The additional portions may be transmitted on request by the client 204.

The operations of embodiment 200 represent a simplified process by which a streaming application may be installed and executed. In cases where the streaming application may not be compatible with the host operating system, a virtual operating system may be launched and the streamed application may be executed in the virtual operating system.

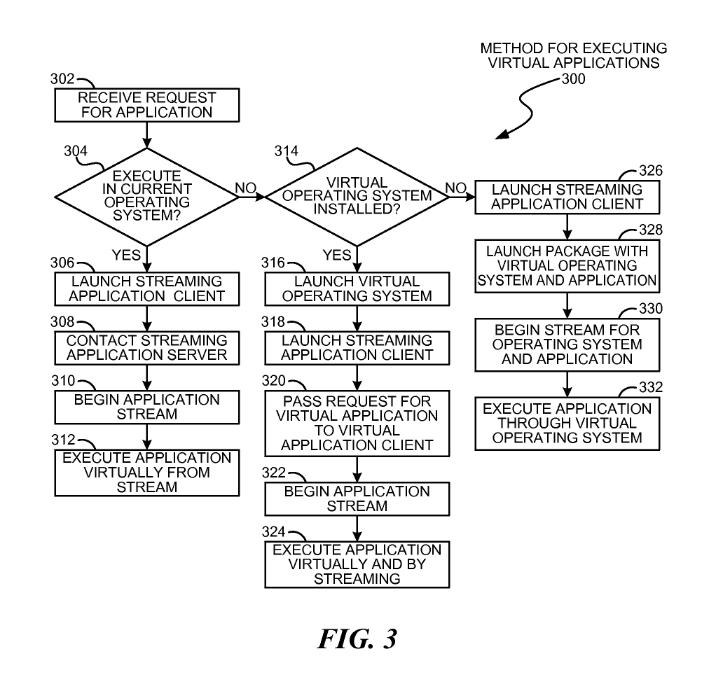

FIG. 3 is a flowchart illustration of an embodiment 300 showing a method for executing streaming virtual applications. Embodiment 300 illustrates a process that may be performed by a client device when launching a virtual application.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates three different manners in which a virtual application may be launched and operated, all of which may use streaming technologies. In the first option, the virtual application may be streamed by a streaming client operating in a host operating system. Such a mechanism may provide application to application separation or ‘virtualization’. In the second option, a virtual operating system may be launched and the application may be streamed into a client that operates inside the virtual operating system. In the third option, the virtual operating system along with the application may be streamed to the host device.

In all three mechanisms illustrated in embodiment 300, the application may be operated in a virtualized manner. A virtualized manner may differ from a native manner in that a wrapper, container, application, or other mechanism may be used to separate the operations and configurations of the application from other applications in the operating system in which the application is executed.

A request for the application may be received in block 302. If the application is able to be executed in the host operating system in block 304, the streaming application client may be launched in block 306. The streaming application client may contact a streaming application server in block 308 and the application stream may begin from the server to the client in block 310. The application may be executed from the stream in block 312. In many cases, the application may be executed in a virtual manner in block 312.

In block 304, a determination may be made to execute the application in the host operating system. In some cases, the application may not be compatible with the host operating system and may only operate on a different operating system.

In other cases, an application may be virtualized by virtualizing the operating system in which the application is executed. In such a case, the virtualized operating system may be another instance of the host operating system, but executed by a hypervisor.

In some embodiments, an application may have an operating system identifier that may specify one or more operating systems capable of executing the application. In such embodiments, a comparison may be made in block 304 that may determine if the current host operating system is capable of the execution. If so, the process may continue to block 306. If not, the application may be executed in a virtual application and the process may continue to block 314.

When a virtualized operating system is used, an application may be already installed on the operating system or may be streamed into the virtualized operating system.

If the application may be executed in a different operating system than the host operating system in block 304 and the virtual operating system is already installed in block 314, the virtual operating system may be launched in block 316. In such a situation, the virtual operating system may be installed, configured, and available to be executed in the host operating system. The virtual operating system may be configured to execute with a set of user interface connections as well as a virtual application client.

The streaming application client may be launched in block 318 as a request may be passed from a management client in the host operating system to the streaming application client in the virtualized operating system. The request may contain instructions to launch the application in a streaming mode in the streaming application client.

The streaming application client may begin the stream from the application server in block 322 and the application may execute virtually in block 324 by streaming.

If the virtual operating system is not installed in block 314, the virtual operating system may be streamed to the host operating system using a streaming application client, which may be launched in block 326. The virtual operating system may be packaged with the application, and such a package may be launched in block 328. The streaming application in block 330 may begin by downloading the portions of the operating system and application. The application may be executed through the virtual operating system in block 332.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a processor;
a user interface;
a host operating system operable on said processor;
a first virtualized operating system operable within said host operating system, said first virtualized operating system having user interface interconnections with said host operating system; and
a first application virtualization client operable within said first virtualized operating system and configured to receive and execute an application in said first virtualized operating system.

2. The system of claim 1 further comprising:
a local client operable in said host operating system that:
receives a request for said first application; and
causes said virtualized operating system to be executed and said application to be executed.

3. The system of claim 2, said local client having a link in a start menu, said link being configured to launch said local client such that said application is executed.

4. The system of claim 3, said local client that further:
receives an update, said update identifying a second application to execute in a virtual manner; and
adding a second line in said start menu, said second link being configured to launch said local client such that said second application is executed in a second virtualized operating system.

5. The system of claim 4, said first virtualized operating system being a different operating system than said second virtualized operating system.

6. The system of claim 4, said second virtualized operating system being an instance of said first virtualized operating system.

7. The system of claim 1, said user interface connections enabling a cut and paste operation between a second application operable in said host operating system and said application.

8. The system of claim 1, said first virtualized operating system being streamed to said system.

9. The system of claim 8, said first virtualized operating system comprising said first application, said first application being operable natively in said first virtualized operating system.

10. A method performed on a computer processor operating a host operating system, said method comprising:
receiving a user selection for a first application;
launching a virtualized operating system within said host operating system, said virtualized operating system having a user interface connection to said host operating system;
executing said first application within said virtualized operating system, said first application being streamed from an application server.

11. The method of claim 10, said virtualized operation system being streamed from said application server.

12. The method of claim 11, said first application being pre-installed in said virtualized operating system.

13. The method of claim 11, said first application being streamed from said application server.

14. The method of claim 10, said user interface connection comprising file sharing between said host operating system and said first application.

15. The method of claim 10, said user interface connection comprising printer sharing between said host operating system and said first application.

16. A client device comprising:
a processor;
a user interface;
a network connection to a streaming application server;
a host operating system operable on said processor;
a management client operable on said host operating system that:
receives a user input;
launches a first virtualized operating system, and within said first virtualized operating system, launches a first application, said first application being received from said streaming application server.

17. The client device of claim 16, said first application that creates a first graphical user interface, said first virtualized operating system being configured to display said first graphical user interface on said user interface.

18. The client device of claim 17 further comprising:
a second application operable in said host operating system.

19. The client device of claim 18, said second application being configured to link to an object in said first application.

20. The client device of claim 19, said first virtualized operating system being streamed from said streaming application server.
